(19) United States
(12) Patent Application Publication
(10) Pub. No.: US 2005/0241963 A1
(43) Pub. Date: Nov. 3, 2005

(54) Dividable container carrier

(76) Inventor: Edward J. Slomski, Huntley, IL (US)

Correspondence Address: TAYLOR & AUST, P.C.;ILLINOIS TOOL WORKS INC., 142 S. MAIN ST, PO BOX 560, AVILLA, IN, 46710, US

(21) Appl. No.: 10/836,016

(22) Filed: Apr. 30, 2004

(51) Int. Cl. B66C 1/10; B65D 75/00

(52) U.S. Cl. 206/150; 206/199; 294/87.2

(57) ABSTRACT

A carrier for containers has loops for individually securing containers therein and perforation lines through the carrier for separating the carrier into at least two subgroups of containers without removing containers from the loops.

### FIELD OF THE INVENTION

The present invention relates to packages for groups of containers, and, more particularly, to plastic carriers having arrays of loops for engaging and holding individual containers, with the carrier being dividable by the consumer into individual subgroups.

### BACKGROUND OF THE INVENTION

Container carriers are used to unitize a plurality of containers, such as bottles or cans, into conveniently saleable quantities. Plastic carriers have achieved wide acceptance for their performance, low weight, low cost and versatility in being adapted for containers of different sizes and shapes. The general design for plastic carriers includes apertures in a stretchable plastic material. The apertures are sized and shaped to stretch around the periphery of the containers to be held, either bottles or cans. For convenient carrying of a group of containers held by the carrier, various types of hand-grasps are known. Automated machinery is available for attaching stretchable plastic carriers to containers quickly and efficiently.

In one known design, the carrier is formed from a single sheet of material and has a handle formed at one side. In another known design, two sheets of plastic material are juxtaposed over one another. Handle portions and container engaging portions are stamped from the juxtaposed webs simultaneously. The webs are fused or welded along selected portions. The resulting handle portion is thereby a double thickness of material, and single-ply container engaging portions freely depend from the handle portion along each side thereof. In still other known designs, separate handle portions are attached separately to the container engaging portions.

A trend in the beverage industry is to group larger quantities of containers for sale. Twelve container groupings are common and have achieved widespread consumer acceptance. Case size groupings of twenty-four containers also are widely available. Large groupings are convenient for both the retailer and consumer, reducing the number of individual packages that must be handled.

A disadvantage of packages having large container groupings is that the packages are not sub-dividable, and many loose their integrity when opened. This can be inconvenient if the entire package is not to be used in the same manner or at the same location. From a twenty-four pack, for example, a consumer may desire to refrigerate a small number and store the remainder. A consumer may desire to take less than a complete package on an outing or to another location. This has been possible in the past only by handling at least some of the containers from the package individually.

What is needed in the art is a container carrier that can be divided in sub-groups of containers while the containers remain secured in sub-group portions of the carrier.

### SUMMARY OF THE INVENTION

The present invention provides a plastic carrier with an array of loops having one loop for each container, and perforations creating tear lines between groups of loops such that the carrier can be divided without releasing containers from the loops.

In one form thereof, the invention provides a container carrier with at least a sheet of pliable material defining an array of loops each adapted for surrounding and holding a container. A handle portion is connected to the array; and perforations separate groups of loops in the array. The perforations are arranged for tearing the material to separate the array into at least a first sub-unit and a second sub-unit while retaining containers in the loops, and for separating the handle into sub-portions each connected to a different one of the sub-units.

In another form thereof, the invention provides a carrier for containers with a container holding portion defining an array of loops each adapted for surrounding and holding a container; and a handle portion connected to the container holding portion. Perforations are adapted and arranged for dividing the container holding portion and the handle portion into at least a first and a second sub-unit each having some of the loops and a sub-portion of the handle portion.

In a further form thereof, the invention provides a method of using a package of containers. The package has a plurality of containers secured individually in loops in an array of interconnected loops, at least some loops separated from others by perforation lines. The package has a handle connected to the array. The method includes steps of: transporting the package intact, separating the package by tearing at least one of the perforation lines and dividing the package into at least two sub-units each containing some of the loops and a sub-portion of the handle; and removing a container from one of the sub-units after the step of separating the package.

An advantage of the present invention is providing a package that retains individual containers in a secure manner even while the carrier is being divided to provide subgroups of containers.

Another advantage of the present invention is providing a container carrier that improves consumer convenience in using the containers held in large groupings.

Other features and advantages of the invention will become apparent to those skilled in the art, upon review of the following detailed description, claims and drawings, in which like numerals are used to designate like features.

### BRIEF DESCRIPTION OF THE DRAWINGS

FIG. 1 is a plan view of a container carrier in accordance with the present invention;

FIG. 2 is a plan view of another carrier in accordance with the present invention;

FIG. 3 is a plan view of a further form of carrier in accordance with the present invention; and

FIG. 4 is a plan view of still another form of carrier in accordance with the present invention.

Before the embodiments of the invention are explained in detail, it is to be understood that the invention is not limited in its application to the details of construction and the arrangements of the components set forth in the following description, or illustrated in the drawings. The invention is capable of other embodiments and of being practiced or being carried out in various ways. Also, it is understood that the phraseology and terminology used herein are for the purpose of description, and should not be regarded as limiting. The use herein of “including” and “comprising”, and variations thereof is meant to encompass the items listed thereafter, and equivalents thereof, as well as additional items and equivalents thereof.

### DETAILED DESCRIPTION OF THE PREFERRED EMBODIMENT

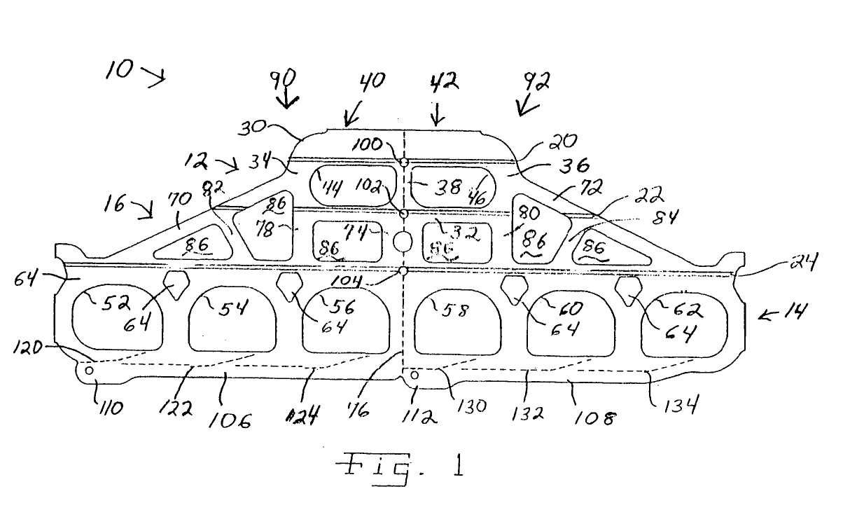

Referring now more specifically to the drawings and to FIG. 1 in particular, numeral 10 designates a container carrier in accordance with the present invention. Carrier 10 includes a handle portion 12 and a container holding portion 14 connected to each other by a suspension portion 16 of handle portion 12. Carrier 10 is made of flexible, resilient material that can be stretched significantly without breaking. Low-density polyethylene is a suitable plastic from which carrier 10 can be made.

Carrier 10 is formed of two juxtaposed webs or sheets, joined to each other by a plurality of welds 20, 22 and 24. Welds 20, 22 and 24 adhere the sheets together in discrete areas. Three such welds 20, 22 and 24 are shown in the drawings; however, it should be understood that more or fewer welds 20, 22 and 24 can be used, and can be located in different areas of carrier 10. Further, each weld 20, 22 and 24 can be a continuously fused bond between the sheets throughout the length of the weld, or may include a plurality of discrete weld segments within the length of the weld. The manner of making welds 20, 22 and 24, is well-known to those skilled in the art, and will not be described in greater detail herein. In the areas between welds 20, 22 and 24 the juxtaposed sheets are separate from each other, but co-extensively positioned.

Handle portion 12 is a double thick layer formed from the juxtaposed sheets secured by welds 20 and 22. Handle portion 12 in each sheet includes a top segment 30, a bottom segment 32, end segments 34 and 36. An intermediate segment 38 between top and bottom segments 30, 32 separates handle portion 12 into a first handle sub-portion 40 and a second handle sub-portion 42 having handle openings 44 and 46, respectively, through which the hand or fingers of a person can be extended for grasping carrier 10.

Container engaging portion 14 comprises an array of individual loops 52, 54, 56, 58, 60 and 62 formed in each of the juxtaposed sheets, each adapted to be stretched over an end of a container to be transported in carrier 10. Loops 52, 54, 56, 58, 60 and 62 in each of the sheets extend freely away from weld 24, weld 24 being formed as a continuous bond between juxtaposed stringers 64 in the sheets. The juxtaposed sheets are not attached to each other outwardly beyond weld 24 in stringer 64 hereby allowing each opposite side of the array of loops 52, 54, 56, 58, 60 and 62 to be moved laterally with respect to weld 24. Those skilled in the art will understand that the shapes of loops 52, 54, 56, 58, 60, and 62 will be different for different applications and uses for carrier 10, depending on the type, size and shape of containers to be secured in carrier 10. Thus, for example, the shapes thereof will be different for cans than for bottles. Apertures 66, of various size, shape and location, are cut into the juxtaposed sheets during stamping, to provide the necessary stretching and shaping of loops 52, 54, 56, 58, 60 and 62 to secure containers therein.

Each loop or sleeve 52, 54, 56, 58, 60 and 62 is adapted to secure a container therein, individually and separately. In the embodiment illustrated, carrier 10 is capable of holding twelve containers, with six containers being held on each side of handle portion 14. However, it should be understood that carrier 10 can be adapted for securing more or fewer containers. Further, carrier 10 can be adapted for securing two rows of containers on each side of handle portion 12. In such case, arrays 50 and 70 each include two adjacent rows of adjacent loops.

Handle suspension portion 16 interconnects main handle portion 12 with container engaging portion 14. Suspension portion 16 is a double thick layer formed from the juxtaposed sheets, secured by welds 22 and 24. Suspension portion 16 in each sheet includes first and second end struts 70 and 72, respectively that interconnect first and second handle end portions 40, 42 respectively, with stringer 64 near the outermost container loops of container holding portion 14.

A post 74 of suspension portion 16 substantially aligns with intermediate segment 38 of handle portion 12 and with material between the two center loops 56 and 58. Thus, a substantially continuous region of material extends from handle top segment 30 to the outer edge of container holding portion 14, and a line of perforations 76 extends through the material from the outer edge of container holding portion 14 to the outer edge of handle top segment 30. Individual perforations in the line of perforations 76 are relatively short, spaced cuts along which the material of carrier 10 can be torn. Center struts 78, 80 are provided on opposite sides of post 74 between outer areas of first and second handle sub-portion 40, 42 and stringer 64. Braces 82, 84 are provided between the elongated end struts 70, 72, respectively, and stringer 64. Suspension portion 16 thereby defines a plurality of apertures 86 of different size and shape.

By tearing carrier 10 along line of perforations 76, carrier 10 can be separated into two sub-units, 90, 92 each of which contains a part of handle portion 12. Thus, sub-unit 90 includes first handle sub-portion 40, and second sub-unit 92 includes second handle sub-portion 42. In the embodiment illustrated in FIG. 1, an original twelve-pack can be divided into two six-packs, while containers remain held in loops 52, 54, 56, 58, 60 and 62. To facilitate tearing across welds 20, 22 and 24 apertures 100, 102 and 104 are provided where the line of perforations 76 crosses welds 20, 22, 24, respectively.

Each of the juxtaposed sheets has outer margin portion 106 and 108, in first and second sub-units 90 and 92, respectively. Margin portion 106 extends along loops 52, 54 and 56 and margin portion 108 extends along loops 58, 60 and 62. Margin portions 106 and 108 define first and second tabs 110 and 112, respectively. Tabs 110 and 112 are provided for grasping by the consumer, for releasing containers from loops 52, 54, 56, 58, 60 and 62.

Lines of perforations 120, 122 and 124 are provided in margin portion 106, angling toward loops 52, 54 and 56, respectively. Perforations 120 extend from an edge of carrier 10 just above tab 110 toward the interior of loop 52. Perforations 122 extend from near perforations 120 toward the interior of loop 54. Perforations 124 extend from near perforations 122 toward the interior of loop 56.

Lines of perforations 130, 132 and 134 are provided in margin portion 108, angling toward loops 58, 60 and 62, respectively. Perforations 130 extend from an edge of second sub-unit 92 when carrier 10 is torn along line of perforations 76, just above tab 112, toward the interior of loop 58. Perforations 132 extend from near perforations 130 toward the interior of loop 60. Perforations 134 extend from near perforations 132 toward the interior of loop 62.

In using carrier 10 shown in FIG. 1, a consumer can conveniently purchase and carry a twelve-pack of containers as a single package. Thereafter, by tearing carrier 10 along perforations 76, the consumer can divide the package easily and conveniently into two sub-units, each including six containers. Each sub-unit 90, 92 includes a handle sub-portion 40, 42, respectively, and can be carried easily and conveniently. Furthermore, one or more of apertures 86 can be used as a hand grasp area for holding sub-units 90, 92. All containers held in carrier 10 remain secured in one or the other sub-unit 90, 92. Individual containers need not be separated from carrier 10 until use of the container is intended. To remove containers from carrier 10, tab 110 or tab 112 is grasped to tear perforations 120, 122 and/or 124 or perforations 130, 132 and/or 134 to release 1, 2 or 3 containers from each of the sub-units 90, 92. Each sub-unit 90, 92 includes a corresponding portion of the array of loops on the opposite side not shown in FIG. 1. Each further includes corresponding tabs and perforations on the opposite side, and four, five or six containers can also be released from each of the sub-units 90-92 by tearing the equivalent perforations on the side opposite the side shown in FIG. 1.

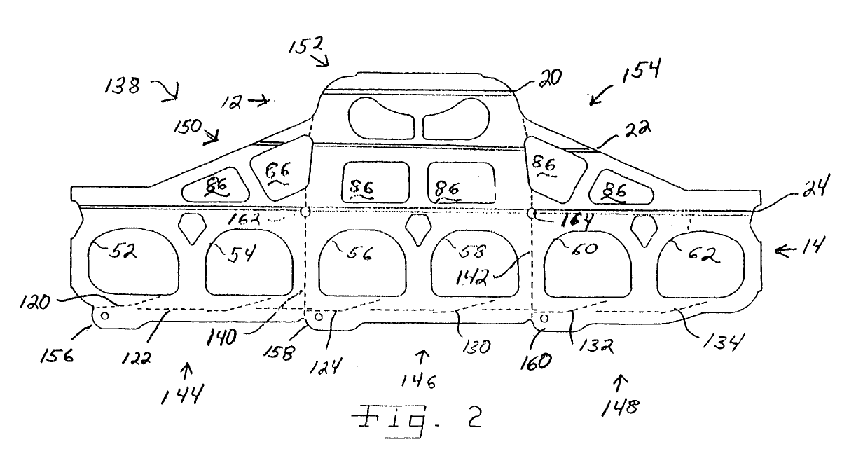

FIG. 2 illustrates a second embodiment of the invention in which a twelve-pack of containers can be divided into three sub-units, each including four containers. Carrier 138 shown in FIG. 2 is similar to carrier 10 described previously, and features of carrier 138 similar to those described above for carrier 10 are designated with the same reference numerals as in FIG. 1.

Carrier 138 includes transverse lines of perforations 140 and 142 from an outer edge of container holding portion 14 to an outer edge of handle portion 12. Thus, the carrier is divided into three sub-units 144, 146 and 148, each including a handle sub-portion 150, 152, 154, respectively. Along the outer margin of the array of loops, individual tabs 156, 158 and 160 are provided to initiate tearing along perforation lines leading into the loops for releasing containers as described previously with respect to carrier 10. To facilitate tearing across weld 24 apertures 162 and 164 are provided where the lines of perforations 140, 142, respectively, cross weld 24. Thus, in a manner similar to that described above with respect to carrier 10, carrier 138 illustrated in FIG. 2 can be divided into a four-pack and an eight-pack of containers or into three four-packs of containers. Each sub-unit 144, 146, 148 includes a handle sub-portion by which it can be carried conveniently, such as by grasping handle portion 12 or the material defining one or another of apertures 86 in suspension portion 16.

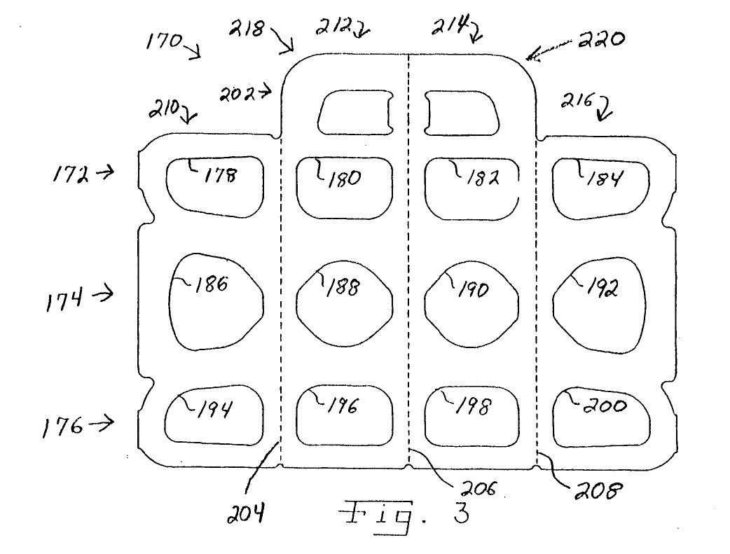

FIGS. 1 and 2 illustrate embodiments of the present invention for twelve-pack carriers having two rows of six loops and a so-called center-lift handle. FIG. 3 illustrates a carrier 170 in accordance with the present invention, which has three rows 172, 174, 176 of loops. Carrier 170 is stamped from a single sheet of material, and requires no welds. Row 172 includes four loops 178, 180, 182 and 184. Row 174 includes four loops 186, 188, 190 and 192. Row 176 includes four loops 194, 196, 198 and 200. A side handle portion 202 is provided adjacent row 172. While shown over only the middle two columns of loops, handle portion 202 can be extended to be substantially the full length of row 172. Transverse lines of perforations 204, 206 and 208 are provided across rows 172, 174 and 176, thereby dividing carrier 170 into four sub-units 210, 212, 214 and 216. Carrier 170 can thereby be separated into a sub-unit of three containers and a further sub-unit including nine or various combinations of three container sub-units such as two equal six-packs, a three-pack and a nine-pack, two three-packs and a six-pack or four three-packs. Handle portion 202 is divided by perforations 206 into at least two handle sub-portions 218, 220 and may be further divided into four handle sub-portions by perforations 204 and 208 if handle portion 202 extends the full width of row 172. Versatility and convenience are enhanced for the consumer by enabling the consumer to divide the package as needed and when needed into a variety of sub-units of different sizes.

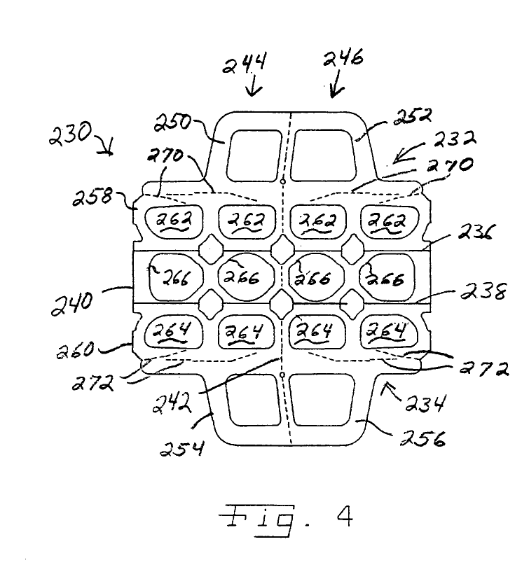

FIG. 4 illustrates yet another embodiment of the invention wherein a carrier 230 includes two separate handle portions 232, 234 welded at weld lines 236, 238, respectively, to an array of loops 240. A transverse line of perforations 242 is provided to separate the carrier into two equal six-pack sub-units 244, 246. However, those skilled in the art will readily understand that additional transverse perforation lines can be provided to thereby separate carrier 230 into sub-units, each including three containers. Handle portions 232, 234 each includes two hand-grasps 250, 252 and 254, 256, respectively, and suspension portions 258, 260 defining apertures 262, 264, respectively. It should be noted that each aperture 262, 264 is aligned directly over a similarly shaped aperture in array 240, with array 240 further including a center row of loops 266 between handle portions 232, 234. A punching operation to form carrier 230 is performed through all layers thereof, including handle portions 232, 234 and array 240. Therefore, opening perforations 270, 272 are formed in the overlapping material of array 240 and handle portions 232, 234 there above. Perforations 270, 272 in array 240 are used to open individual loops and release containers held therein. Perforations 270, 272 in handle portions 232, 234 can be used to remove one or more of handgrasps 250, 252, 254 and 256, and sub-units 244, 246 can be carried by grasping apertures 248, 250 in suspension portions 244, 246.

The present invention allows the retailer to conveniently handle and sell large groups of containers in a single package, while further allowing the consumer to conveniently transport the large package and thereafter separate the package into smaller groups of containers still held by carrier portions. The invention provides means to divide the carrier handle into handle sub-portions. The carrier can be divide without separating portions of the carrier from other portions of the carrier still holding containers. Even fully loaded carriers can be divided without removing individual containers from the loops in which the containers are held. Convenience is enhanced for both the retailer and the consumer.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention, and will enable others skilled in the art to utilize the invention. The claims are to be construed to include alternative embodiments to the extent permitted by the prior art.

Various features of the invention are set forth in the following claims.

1. A container carrier comprising:
at least a sheet of pliable material defining an array of loops each adapted for surrounding and holding a container;
a handle portion connected to said array; and
at least a one line of perforations separating groups of loops in said array, perforations in said at least one line of perforations adapted and arranged for tearing said material to separate said array into at least a first sub-unit and a second sub-unit while retaining containers of said sub-units secured in said loops, and said at least one line of perforations extending through said handle portion for separating said handle portion into at least first and second handle sub-portions each connected to a different one of said sub-units.

2. The container carrier of claim 1, said array including twelve said loops and said perforations separating said loops into two sub-units each having six said loops.

3. The container carrier of claim 1, including a plurality of lines of perforations for separating said array into at least three sub-units.

4. The container carrier of claim 3, said array including twelve said loops and said perforations separating said loops into three sub-units each having four said loops.

5. The container carrier of claim 3, said array including twelve said loops and said perforations separating said loops into four sub-units each having three said loops.

6. The container carrier of claim 1, said array comprising a first sheet and said handle comprising a second sheet welded to said first sheet.

7. The container carrier of claim 1, said array and said handle comprising a single sheet of material

8. The container carrier of claim 1, said carrier comprising first and second super imposed sheets, said handle comprising a portion of each said sheet and said array including loops defined in each said sheet.

9. The container carrier of claim 8, said perforations separating said carrier into at least two sub-units each including loops from each said sheet.

10. The container carrier of claim 8, said perforations separating said carrier into at least three sub-units each including loops from each said sheet.

11. The container carrier of claim 1, said array including further perforations for opening each said loop.

12. A carrier for containers comprising:
a container holding portion defining an array of loops each adapted for surrounding and holding a container;
a handle portion connected to said container holding portion; and
perforations adapted and arranged through said container holding portion and said handle portion for dividing said container holding portion and said handle portion into at least a first and a second sub-unit each having some of said loops and a sub-portion of said handle portion.

13. The carrier of claim 12, including additional perforations for separating said container holding portion into a third sub-unit having some of said loops.

14. The carrier of claim 13, including still further perforations for separating said container holding portion into a fourth sub-unit having some of said loops.

15. The carrier of claim 13, each of said sub-units having the same number of said loops.

16. The carrier of claim 12, said perforations separating said container holding portion into first, second, third and fourth sub-units, each containing three said loops.

17. A method of using a package of containers including a plurality of containers secured individually in loops in an array of interconnected loops, at least some of which are separated from other loops by perforation lines, the package having a handle connected to the array, said method including the steps of:
transporting the package intact;
separating the package by tearing at least one perforation line and dividing the package into at least two sub-units each containing some of the loops and a sub-portion of the handle; and
removing a container from one of the sub-units after said step of separating the package.

18. The method of claim 17, said step of removing a container performed by tearing a perforation line in a margin of the carrier to open one of the loops.

19. The method of claim 17, said step of separating the package including tearing a second perforation line and dividing the package into three sub-units.

20. The method of claim 19, said step of separating the package including tearing a third perforation line and dividing the package into four sub-units.

21. A process for making a container carrier, comprising:
forming a container holding portion with an array of loops each adapted for surrounding and holding a container;
forming a handle portion connected to the container holding portion; and
perforating the container holding portion and the handle portion to promote dividing the container holding portion and the handle portion into at least a first and a second sub-unit each having some of the loops and a subportion of the handle portion.
